(19) United States
(12) Patent Application Publication
(10) Pub. No.: US 2004/0208261 A1
(43) Pub. Date: Oct. 21, 2004

(54) [DIGITAL DC BIAS ESTIMATION APPARATUS AND METHOD]

(76) Inventor: WEN-CHIANG CHEN, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,083

(22) Filed: Sep. 8, 2003

(30) Foreign Application Priority Data
Apr. 17, 2003 (TW) 92108894

(51) Int. Cl. H04L 25/06

(52) U.S. Cl. 375/319

(57) ABSTRACT

A digital DC bias estimation apparatus and a method thereof for estimating a DC bias of a received signal obtained from a packet after it is received and sampled are provided. The digital DC bias estimation apparatus comprises a symbol boundary detection unit, a preamble pattern identification enabling unit, a preamble pattern identification unit, and a bias calculation unit. The symbol boundary detection unit differentiates a received signal to obtain a differential curve, slices the differential curve into a binary-type comparison base signal by assigning a starting point on a region beyond a transition setting threshold range in the differential curve as a transition point, and issues a boundary signal when a transition is occurred. The preamble pattern identification enabling unit counts a sampling number between two contiguous boundary signals, and the counted sampling number is reset to zero each time the boundary signal occurs, and when the counted sampling number is within an allowable range before it is reset to zero, the preamble pattern identification enabling unit issues a preamble pattern storing signal. The preamble pattern identification unit obtains a pattern of the sliced binary comparison base signal from the comparison base signal during a corresponding period according to the preamble pattern storing signal, compares the pattern of the continuously obtained sliced binary comparison base signals with a predefined preamble pattern, and issues a matching signal when the pattern of the continuously obtained sliced binary comparison base signals matches the predefined preamble pattern. The bias calculation unit electrically couples to the preamble pattern identification unit, and outputs an average potential of peaks of the received signals between two contiguous boundary signals at the same time when the preamble pattern identification unit issues the matching signal, wherein the received signals are matched to the predefined preamble pattern and received before the matching signal is occurred.

### CROSS REFERENCE TO RELATED APPLICATIONS

This application claims the priority benefit of Taiwan application serial no.92108894, filed on Apr. 17, 2003.

### BACKGROUND OF INVENTION

1. Field of Invention

The present invention relates to a DC bias estimation apparatus and a method thereof, and more particularly, to a digital DC bias estimation apparatus and a method thereof.

2. Description of Related Art

A DC bias generated after frequency discriminated which is resulted from a frequency deviation between a sending side and a receiving side exists in a wireless communication environment that uses frequency modulation. Therefore, in order to demodulate the signal correctly, a DC bias in the signal has to be estimated and removed from the signal.

In the currently used DC bias estimation technique, a backend controller is generally used to control an analog integrator or a digital accumulator, so as to estimate the DC bias it contains based on the preamble bits. However, a severe defect exists in such configuration. For example, the backend controller has to fulfill the basic requirement of the frame synchronization, so as to understand the position of each filed. Further, the preamble bits must be long enough, so that it has enough number of the received bits for averaging, so as to accurately estimate the DC bias it contains. Finally, the backend controller also needs the capability for immediately stopping the estimation operation when it has to be stopped, so as to avoid loss of physical data bits caused by the erroneous estimation of the DC bias resulting from erroneously mixing up the physical data bits into the DC bias estimation.

Therefore, the smoothly performing DC bias estimation method mentioned above is obviously built on the premise that the preamble bits must be long enough and the DC bias should be estimated before the physical data bit is received. In order to satisfy such a premise, most of the currently used systems requiring the DC bias calibration obviously need a long enough preamble filed for performing the DC bias estimation.

Since the preamble bits are long enough, the DC bias estimation method used in the prior art can proceed even after the starting point of the preamble bits, instead it has to concentrate on the ending point of the preamble bits, so as to avoid the error occurred in the DC bias estimation and reduce the possibility of losing the physical data bits.

However, if the DC bias estimation is performed by only using a short preamble field, the DC bias estimation has to start at the same time as the preamble bits are received. This means that whether the preamble bit arrives or not must be determined before achieving frame synchronization. One of these two major premises mentioned above has to be satisfied, otherwise, it will be very difficult to perform the DC bias estimation. One of the methods is to identify the boundary of each bit according to the duration of each received bit period, so as to identify the preamble bit pattern under the premise that the DC bias is not too large to cause the lose of the zero crossing of the received signal preventing from the identification. However, its application is significantly limited by such premise, and thus it is not suitable for the system having a larger frequency deviation (so that has a larger DC-offset) between the sending side and the receiving side. Optionally, under the premise that the preamble bits have good auto-correlation, the correlation between the received bit pattern and the preamble pattern is calculated, so as to identify the preamble bits.

Unfortunately, in the bluetooth technique that has gradually become one of the most popular communication techniques, the preamble bits defined by its communication protocol only have 4 bits, the frequency deviation between the sending side and the receiving side is relatively large, and the 4-bit preamble bits do not have a good auto-correlation characteristic. The bits subsequent to the preamble bits are the access codes which are for the back-end controller to achieve frame synchronization but are not known by the front-end. Therefore, when the preamble bits are very short and the frame synchronization operation cannot be performed in advance in the front-end, the DC bias estimation method used in the prior art obviously cannot be applied in the bluetooth field. Further, the waveform of the bluetooth signal is easily distorted by the noise and the interference. Furthermore, the preamble bits defined by the bluetooth communication protocol do not have a good auto-correlation characteristic.

In summary, for the signal whose preamble bits are significantly reduced (especially for the bluetooth signal), it is hard for the front-end to use the DC bias estimation method commonly used in the prior art to immediately perform the DC bias estimation when the preamble bit just arrives, and hard to complete the DC bias estimation before the physical received signal is received. Further, the bluetooth signal is easily ruined by the noise and the interference and causes signal distortion during the wireless communication. The fact that the access code is subsequent to the preamble bits which have good auto-correlation but the front-end have no way to know in advance makes those two conventional techniques, in which the DC bias estimation immediately starts when the preamble bit just arrives, difficult to apply to such signal.

### SUMMARY OF INVENTION

It is an object of the present invention to provide a digital DC bias estimation apparatus and a method thereof. The preamble bits can be directly identified so as to perform the DC bias estimation according to the preamble bits without having to wait for the backend controller to complete its frame synchronization.

It is a further object of the present invention to provide a digital DC bias estimation apparatus and a method thereof for providing a very good DC bias estimation in the case of a very short preamble bit field, which is similar to the bluetooth signal.

In order to achieve the objects mentioned above and others, the present invention provides a digital DC bias estimation apparatus suitable for estimating a DC bias of a received signal obtained from a packet after it is received and sampled. The digital DC bias estimation apparatus comprises a symbol boundary detection unit, a preamble pattern identification enabling unit, a preamble pattern identification unit, and a bias calculation unit. The symbol boundary detection unit differentiates the received signal to obtain a differential curve, slices the differential curve into a binary comparison base signal by assigning a starting point on a region beyond a transition setting threshold range in the differential curve as a transition point, and emits a boundary signal when a transition is occurred. The preamble pattern identification unit enables the unit to count the sampling number between two contiguous boundary signals, and the counted sampling number is reset to zero each time the boundary signal occurs. When the counted sampling number is within an allowable range before it is reset to zero, the preamble pattern identification unit enables the unit to issue a preamble pattern storing signal. The preamble pattern identification unit obtains a pattern of the sliced binary comparison base signal from the comparison base signal during a corresponding period according to the preamble pattern storing signal, compares the pattern of the continuously obtained sliced binary comparison base signals with a predefined preamble pattern, and issues a matching signal when the pattern of the continuously obtained sliced binary comparison base signals matches the predefined preamble pattern. The bias calculation unit outputs an average potential of peaks of the received signals between two contiguous boundary signals at the same time when the preamble pattern identification unit issues the matching signal, wherein the pattern of the sliced binary comparison base signal matches the predefined preamble pattern and are received before the matching signal is occurred.

In accordance with a preferred embodiment of the present invention, the symbol boundary detection unit further comprises a noise eliminator, a distortion alleviator, a slicer, and a transition detector. The noise eliminator averages a plurality of contiguous curve values in the differential curve, so as to obtain and to output an averaged differential curve. The distortion alleviator outputs the original value of the averaged differential curve when the averaged differential curve mentioned above is beyond the transition setting threshold range, and outputs a previously output value when the averaged differential curve mentioned above is within the transition setting threshold range. The slicer slices a distortion-alleviated signal to generate a sliced binary comparison base signal mentioned above. The transition detector outputs the boundary signal mentioned above when the comparison base signal transition occurs.

In accordance with the other preferred embodiment of the present invention, the preamble pattern identification enabling unit mentioned above further comprises a first counter and an AND gate. The first counter counts the sampling number between two contiguous boundary signals, resets the sampling number to zero and outputs a counting zero signal each time the boundary signal occurs. Further, when the counted sampling number is within an allowable range before it is reset to zero, the first counter issues a bit-enabling signal meaning a proper bit period so as to filter the glitch generated by the distortion in the differential curve and the period that is too long and not receiving any signal. After the counting zero signal, the bit enabling signal, and the boundary signal are input to it, the AND gate operates these signals and outputs the preamble pattern storing signal mentioned above.

In another preferred embodiment of the present invention, besides having the first counter and the AND gate, the preamble pattern identification enabling unit mentioned above further comprises a second counter. The second counter counts the number of the boundary signals, and enables the AND gate for operating it after the number of the boundary signals reaches a predetermined number, so as to filter the level deviation generated by differentiating the received signals whose waveform is first time transformed from null.

In another preferred embodiment of the present invention, the preamble pattern identification unit mentioned above further comprises a shift register and a pattern matching unit. The shift register stores the sliced binary comparison base signals record by record according to the preamble pattern storing signal mentioned above. The pattern matching unit electrically couples to the shift register so as to compare the data stored in the shift register with the predefined preamble pattern.

In another preferred embodiment of the present invention, the bias calculation unit mentioned above further comprises a first shift register and a bias estimation unit. The first shift register stores and outputs the received signals record by record according to the preamble pattern storing signal. The bias estimation unit electrically couples to the first shift register, and obtains and searches for peaks of the received signals stored by the first shift register according to the matching signal mentioned above, and further calculates its average value so as to obtain the estimated DC bias mentioned above.

In another preferred embodiment of the present invention, besides having the first shift register and the bias estimation unit, the bias calculation unit mentioned above further comprises a peak searching unit. The peak searching unit electrically couples to the first shift register, and obtains and outputs the peak of the received signals stored by the first shift register after the previous time of the preamble pattern storing signal enabling the first shift register and before the current time of the preamble pattern storing signal enabling the first shift register according to the continuous preamble pattern storing signals. In the present preferred embodiment, the bias estimation unit calculates an average value of a plurality of peaks in the received signals corresponding to the comparison base signal and matching the predefined preamble pattern, so as to obtain the estimated DC bias.

Further, according to another preferred embodiment of the present invention, besides having the first shift register, the bias estimation unit, and the peak searching unit mentioned above, the bias calculation unit further comprises a second shift register. The second shift register is electrically coupled to the peak searching unit, and stores the peaks output from the peak searching unit record by record according to the preamble pattern storing signal.

Further, in order to accurately estimate DC bias and in accordance with a preferred embodiment of the present invention, besides having the symbol boundary detection unit, the preamble pattern identification enabling unit, the preamble pattern identification unit, and the bias calculation unit, the digital DC bias estimation apparatus provided by the present invention further comprises a correlation unit and a trailer bias estimation unit. The correlation unit subtracts the estimated DC bias, which is previously obtained by estimating the preamble bit filed, from the received signal mentioned above, so as to obtain a set of bias-reduced received signals. The set of bias-reduced received signals is then correlatively operated with a certain predefined correlation signal, and outputs a trailer bit enabling signal when the value obtained from the correlation operation is beyond a set of trailer setting threshold ranges. The trailer bias estimation unit calculates an average value of the trailer bit received signal sampling points according to the trailer bit enabling signal, and outputs the calculation result as a trailer DC bias.

Further, the present invention further provides a digital DC bias estimation method for estimating a DC bias of the received signal obtained from sampling the received packet. The digital DC bias estimation method first differentiates the received signal to obtain a differential curve, and then slices the differential curve into a binary comparison base signal by assigning a starting point on a region beyond a transition setting threshold range in the differential curve as a transition point, and generates a boundary signal when a transition is occurred. The method then counts the sampling number between two contiguous boundary signals, and the counted sampling number is reset to zero each time when the boundary signal is occurred. When the counted sampling number is within a certain allowable range before the counted sampling number is reset to zero, the method issues a preamble pattern storing signal. Then, the method obtains a sliced binary comparison base signal according to the preamble pattern storing signal, compares the pattern of the continuously obtained sliced binary comparison base signals with a certain predefined preamble pattern, and issues a matching signal when the pattern of the continuously obtained sliced binary comparison base signals matches the predefined preamble pattern. Finally, the method outputs an average potential of peaks for each bit filed of the continuously received signals corresponding to the comparison base signal, which matches the predefined preamble pattern, as the estimated DC bias.

In a preferred embodiment of the present invention, the digital DC bias estimation method mentioned above further subtracts the estimated DC bias, which is estimated from the preamble bit filed, from the received signal so as to obtain a set of bias-reduced received signals. Then, the set of bias-reduced received signals is correlatively operated with a set of predefined correlation signals after it is sliced by the slicer, and outputs a trailer bit enabled signal when the value obtained from the correlation operation is beyond a certain trailer setting threshold range. Finally, the trailer bias estimation unit calculates an average value of the received signals corresponding the trailer bits, which have been previously synchronized and are sampled, and outputs the calculation result as a trailer DC bias.

The present invention uses the curve obtained from differentiating the received signal cooperating with other mechanism to determine whether the received signals are the preamble bits or not. The impact of the zero crossing from the DC bias is totally eliminated after it is differentiated. Therefore, it is much easier to know the variance of each bit potential it receives. Thus, the present invention can quickly know the coming of the preamble bits, and obtain the estimated DC bias via the preamble bits that are quickly obtained. Further, if it is intended to obtain a more accurate DC bias when using the bluetooth communication, subsequent trailer fields should be obtained according to the result obtained from the auto-correlation operation, and a more accurate DC bias is further obtained according to the trailer fields.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a circuit block diagram of a preferred embodiment according to the present invention.

FIG. 2A schematically shows a circuit block diagram of a symbol boundary detection unit shown in FIG. 1 of a preferred embodiment according to the present invention.

FIG. 2B schematically shows a comparison diagram for illustrating the relationship between the averaged differential curve and the distortion alleviating signal.

FIG. 2C schematically shows a circuit block diagram of a symbol boundary detection unit of the other preferred embodiment according to the present invention.

FIG. 3A schematically shows a circuit block diagram of a preamble pattern identification enable unit of a preferred embodiment according to the present invention.

FIG. 3B schematically shows a circuit block diagram of a preamble pattern identification enabling unit of the other preferred embodiment according to the present invention.

FIG. 4 schematically shows a circuit block diagram of a preamble pattern identification unit shown in FIG. 1 of a preferred embodiment according to the present invention.

FIG. 5A schematically shows a circuit block diagram of a bias calculation unit shown in FIG. 1 of a preferred embodiment according to the present invention.

FIG. 5B schematically shows a circuit block diagram of a bias calculation unit shown in FIG. 1 of the other preferred embodiment according to the present invention.

FIG. 6 schematically shows a circuit block diagram for estimating the part of signals that have high correlation of a preferred embodiment according to the present invention.

FIG. 7 schematically shows a flow chart of a preferred embodiment according to the present invention.

### DETAILED DESCRIPTION

FIG. 1 schematically shows a circuit block diagram of a preferred embodiment according to the present invention. In the present embodiment, the digital DC bias estimation apparatus 10 comprises a symbol boundary detection unit 100, a preamble pattern identification enabling unit 110, a preamble pattern identification unit 120, and a bias calculation unit 130. The digital DC bias estimation apparatus 10 estimates a DC bias in the received signal rxi obtained from sampling the received packet.

According to the present invention, the symbol boundary detection unit 100 first differentiates the received signal rxi to obtain a corresponding differential curve, and then slices the differential curve into a set of corresponding binary comparison base signals by assigning a starting point on a region beyond a transition setting threshold range in the differential curve as a transition point. Further, the symbol boundary detection unit 100 outputs a boundary signal Pedge when a transition is occurred.

Further, the preamble pattern identification enabling unit 110 electrically couples to the symbol boundary detection unit 100 for receiving the boundary signal Pedge output from the symbol boundary detection unit 100, and counts the sampling number between two contiguous boundary signals Pedge. In other words, the counted sampling number is reset to zero each time the boundary signal Pedge occurs, and is gradually increased depending on the sampling frequency before next boundary signal Pedge occurs. Finally, the preamble pattern identification enabling unit 110 outputs a preamble pattern storing signal Pmatch_EN when the counted sampling number is within a certain allowable range before it is reset to zero.

The preamble pattern storing signal Pmatch_EN output by the preamble pattern identification enabling unit 110 is sent to the preamble pattern identification unit 120. The preamble pattern identification unit 120 obtains a sliced binary comparison base signal rxi_diff according to the preamble pattern storing signal Pmatch_EN. In other words, it is assumed that the preamble pattern identification enabling unit 110 issues a high potential pulse as the preamble pattern storing signal Pmatch_EN mentioned above when the counted sampling number is within a certain allowable range before it is reset to zero. The preamble pattern identification unit 120 compares a pattern, which is formed by its stored continuous sliced binary comparison base signals, with a predefined preamble pattern each time when a high potential pulse appears in the preamble pattern storing signal Pmatch_EN, and issues a matching signal Preamble_EN when the pattern of the sliced binary comparison base signals matches the predefined preamble pattern. After receiving the matching signal Preamble_EN, the bias calculation unit 130 outputs an average potential of peaks of the received signals rxi between the successive high potential pulse of the current preamble pattern storing signal Pmatch_EN corresponding to each bit of the sliced binary comparison base signal rxi_diff that matches the predefined preamble pattern as the estimated DC bias.

For one of the ordinary skill in the art having a better understanding of the technique used in the present invention, more detail diagrams are provided hereinafter for describing the embodiments of the circuit configuration used in each element as shown in FIG. 1 mentioned above.

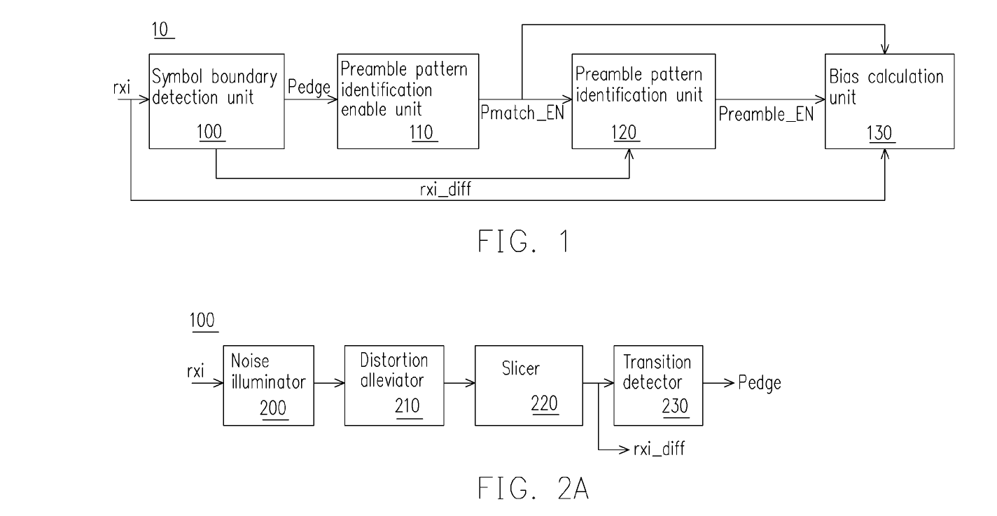

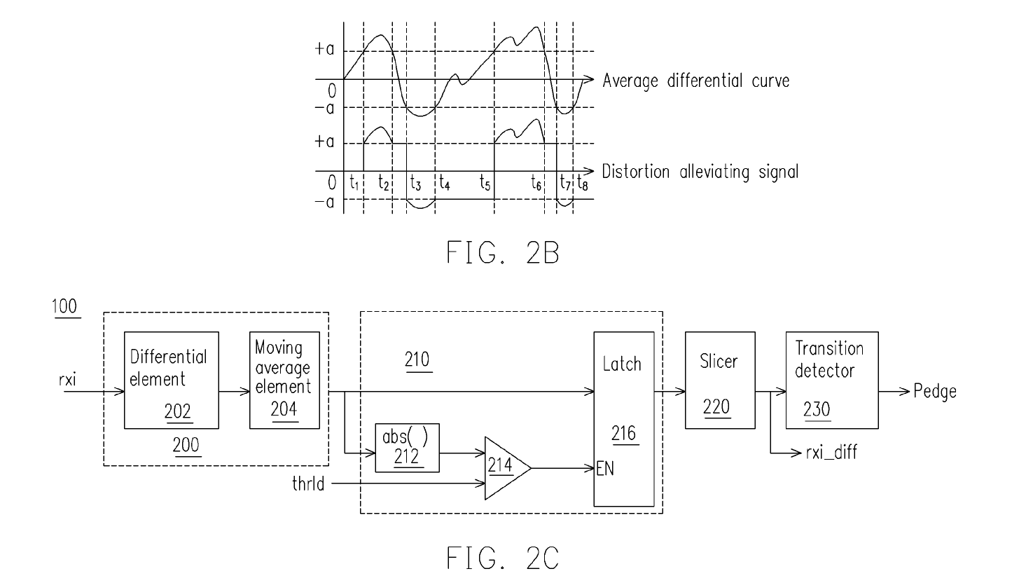

FIG. 2A schematically shows a circuit block diagram of a symbol boundary detection unit 100 shown in FIG. 1 of a preferred embodiment according to the present invention. In the present embodiment, the symbol boundary detection unit 100 comprises a noise eliminator 200, a distortion alleviator 210, a slicer 220, and a transition detector 230. The noise eliminator 200 differentiates the received signal rxi to obtain a corresponding differential curve, and averages a plurality of contiguous curve values in the differential curve, so as to output a set of averaged differential curves. The distortion alleviator 210 outputs the original value of the averaged differential curve when the averaged differential curve is beyond the transition setting threshold range, and outputs a previously output value when the averaged differential curve is within the transition setting threshold range. Thus, the distortion alleviator 210 converts the original average differential curve into a corresponding set of the distortion alleviated signals.

The operation of the distortion alleviator 210 mentioned above is described in detail hereinafter with referring to FIG. 2B, which schematically shows a correlation between the average differential curve and the distortion alleviated signal. Wherein, a range between +a and a is the transition setting threshold range mentioned above, and the initial value of the distortion alleviated signal is assumed to be 0.

It is known from FIG. 2B that the averaged differential curve from time point 0 to t1 is within the transition setting threshold range, thus the distortion alleviated signal is kept as a previously output value from time point 0 to t1, i.e. kept as the initial value 0. Then, from time point t1 to t2, since the averaged differential curve is beyond the transition setting threshold range, part of the corresponding distortion alleviated signals are relatively changed according to the value of the average differential curve. Similar situation also appears in the durations from time point t3 to t4, t5 to t6, and t7 to t8.

Then from time point t2 to t3, since the averaged differential curve entering into the transition setting threshold range starts from time point t2, and exits the transition setting threshold range at time point t3. The distortion alleviated signal is relatively fixed on a value that first exceeds the transition setting threshold range during this period, i.e. the +a appeared on the time point t2. At time point t3, since the averaged differential curve is divorced from the transition setting threshold range starting from a, the distortion alleviated signal is also changed from +a to a instantly, and a corresponding variance according to the value of the averaged differential curve exceeding the transition setting threshold range is further generated. Similar situation also appears in the durations from time point t4 to t5, and t6 to t7.

Referring to FIG. 2A, after the distortion alleviated signal is obtained by the distortion alleviator 210 from the operation mentioned above, the slicer 220 slices the distortion alleviated signal into a corresponding sliced binary comparison base signal rxi_diff, and outputs the sliced binary comparison base signal rxi_diff to the subsequent transition detector 230 and the preamble pattern identification unit 120. The transition detector 230 then outputs a boundary signal Pedge when a transition of the received sliced binary comparison base signal rxi_diff occurs.

FIG. 2C schematically shows a circuit block diagram of a symbol boundary detection unit of the other preferred embodiment according to the present invention. In the present embodiment, the noise eliminator 200 comprises a differential element 202 and a moving average element 204, and the distortion alleviator 210 comprises an absolute value converter 212, a comparator 214, and a latch 216. The received signal rxi is first sent to the differential element 202 for performing a differential operation, the differential curve obtained from the differential operation is further sent to the moving average element 204, so as to obtain a flatter averaged differential curve from a plurality of contiguous values in the averaged differential curve. Then, the values included in the averaged differential curve are sent to the latch 216 and the absolute value converter 212 simultaneously. After converted by the absolute value converter 212, the values originally included in the averaged differential curve are converted into a value of greater than or equal to 0, and the converted value is then compared with a threshold value thrld, i.e. the +a in FIG. 2B mentioned above.

When the comparison result of the comparator 214 indicates the converted value is greater than or equal to the threshold value, the signal output from the comparator 214 enables the latch 216 and latches the value in the corresponding averaged differential curve as the distortion alleviated signal, which is then output to the slicer 220. Contrarily, when the comparison result of the comparator 214 indicates the converted value is smaller than the threshold value, the signal output from the comparator 214 disables the latch 216, thus the value in the corresponding average differential curve is not output to the slicer 220. Instead, in such case the value previously latched in the latch 216 is output to the slicer 200 and becomes a part of the distortion alleviated signal again. The operation of the slicer 220 and the transition detector 230 are described in detail in the explanation of FIG. 2A above, therefore it is omitted herein.

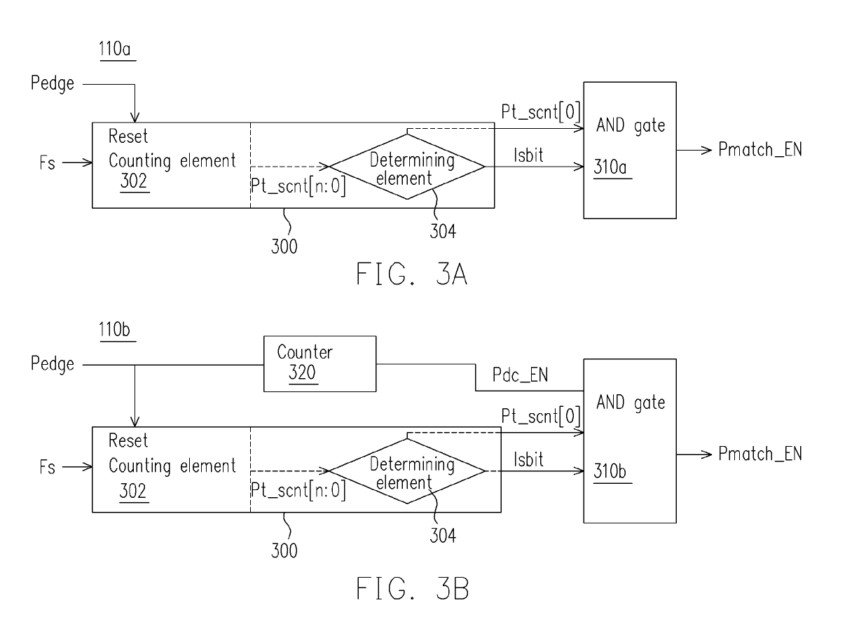

FIG. 3A schematically shows a circuit block diagram of a preamble pattern identification enabling unit of a preferred embodiment according to the present invention. In FIG. 3A, the preamble pattern identification enabling unit 110a comprises a counter 300 and an AND gate 310a. The counter 300 counts the sampling number between two contiguous boundary signals Pedge, resets the sampling number to zero and outputs a counting zero signal Pt_scnt [0] each time when the boundary signal Pedge occurs. Further, the counter 300 issues a bit enabling signal Isbit when the sampling number is still within a certain allowable range. The counting zero signal Pt_scnt [0], the bit enabling signal Isbit, and the boundary signal Pedge mentioned above are input into the AND gate 310a, and the AND gate 310a operates these signals and outputs the preamble pattern storing signal Pmatch_EN mentioned above.

In order to achieve the effect mentioned above, the counter 300 of the present embodiment comprises a counting element 302 and a determining element 304. The counting element 302 increases the sampling number Pt_scnt [n:0] one by one by using the sampling frequency Fs as its operating frequency, and uses the boundary signal Pedge as a trigger signal for triggering and resetting its counting value. Besides this, the counting element 302 outputs the counting number Pt_scnt [n:0] to the determining element 304. Besides outputting the counting zero signal Pt_scnt [0] to the AND gate 310a when the counting value is down to 0, the determining element 304 also correspondingly adjusts the potential of the bit enabling signal Isbit based on whether the counting value is within a certain allowable range or not. Finally, the AND gate 310a determines the potential of its output preamble pattern storing signal Pmatch_EN according to the counting zero signal Pt_scnt [0] and the bit enabling signal Isbit generated by the counter.

Further, the preamble pattern identification enabling unit 110 shown in FIG. 1 also can be implemented by using other circuit configuration. For example, FIG. 3B schematically shows a circuit block diagram of a preamble pattern identification enabling unit of the other preferred embodiment according to the present invention. Besides having the basic counter 300 and the AND gate 310b, the preamble pattern identification enable unit further comprises a counter 320. The counter 320 counts the number of the boundary signal Pedge, and outputs its output signal Pdc_EN to the AND gate 310b as the other input signal of the AND gate 310b. The counter 320 raises the potential of the output signal Pdc_EN of the counter 320 to logic “1” only whenever the number of the boundary signal Pedge is greater than a predetermined value. Therefore, part of the noise received before the physical received signal arrives can be eliminated.

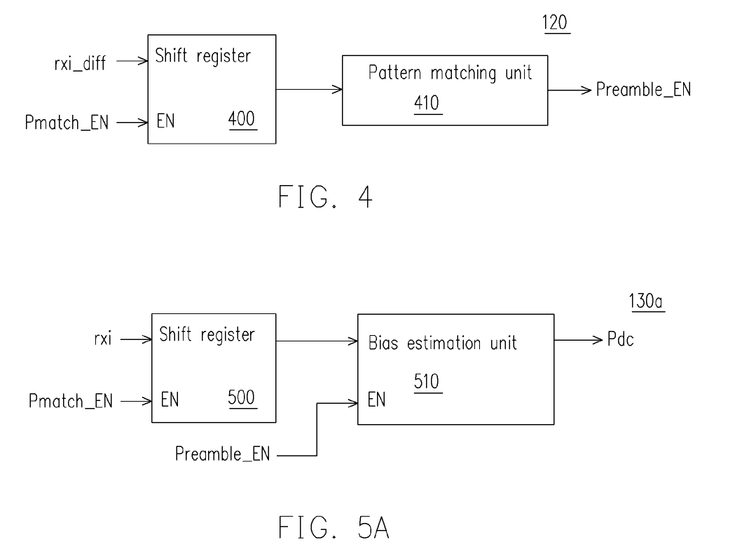

FIG. 4 schematically shows a circuit block diagram of a preamble pattern identification unit 120 in the digital DC bias estimation apparatus 10 shown in FIG. 1 of a preferred embodiment according to the present invention. In the present embodiment, the preamble pattern identification unit 120 comprises a shift register 400 and a pattern matching unit 410. In the case that the preamble pattern storing signal Pmatch_EN enables the shift register 400, the shift register 400 receives and stores the sliced binary comparison base signals rxi_diff generated by the symbol boundary detection unit 100 mentioned above, and outputs the original saved data after it has been shifted for one unit. Contrarily, if the potential of the preamble pattern storing signal Pmatch_EN cannot enable the shift register 400, the sliced binary comparison base signal rxi_diff is not stored into the shift register 400, thus the data originally stored in the shift register 400 is not changed. When the period between the current time of the preamble pattern storing signal Pmatch_EN enabling the shift register and the previous time of the preamble pattern storing signal Pmatch_EN enabling the shift register exceeds a certain time threshold set in advance, the data originally stored in the shift register 400 are all cleared, so as to prevent the miss-determining problem due to the non-continuously stored data pattern happened to match the predefined preamble pattern from happening.

The pattern matching unit 410 electrically couples to the output of the shift register 400, so as to compare and determine whether the pattern of the data stored in the shift register 400 matches the predefined preamble pattern or not. If the comparison result indicates that the pattern of the data stored in the shift register 400 matches the predefined preamble pattern, the pattern matching unit 410 converts the potential of its output signal, i.e. the potential of the matching signal Preamble_EN mentioned above, into a predefined logic (may be a logic “0” or a logic “1), so as to indicate that the preamble pattern is contained in the received signal. The predefined preamble pattern can be either built in the pattern matching unit 410 or input into the pattern matching 410 from outside.

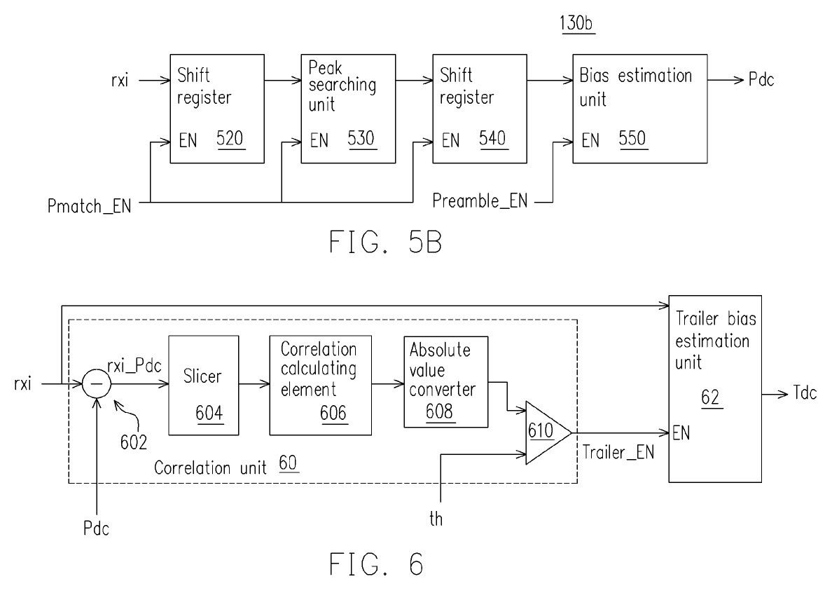

FIG. 5A schematically shows a circuit block diagram of a bias calculation unit 130 in the digital DC bias estimation apparatus 10 shown in FIG. 1 of a preferred embodiment according to the present invention. In the present embodiment, the bias estimation unit 130a comprises a shift register 500 and a bias estimation unit 510. The shift register 500 determines whether to perform the operation or not according to the preamble pattern storing signal Pmatch_EN generated by the preamble pattern identification enabling unit 110 mentioned above. When the preamble pattern storing signal Pmatch_EN is able to enable the shift register 500, the shift register 500 starts to store and output the received signal rxi mentioned above record by record. The bias estimation unit 510 electrically couples to the output of the shift register 500, so as to obtain the data stored in the shift register 500 according to the potential of the matching signal Preamble_EN, and to output an average value as the estimated DC bias Pdc after calculating the average potential of the data.

However, under normal situation, since there are a lot of the sampling points for sampling signals, a relatively great number of the operations need to be performed in the bias estimation unit 510. In order to reduce the number of the operations performed in the bias estimation unit, a certain level sampling can be performed on the data between the bias estimation unit 510 and the shift register 500. For example, FIG. 5B schematically shows a circuit block diagram of a bias calculation unit of the other preferred embodiment according to the present invention. In the present embodiment, the bias calculation unit 130b comprises two shift registers 520 and 540, a peak searching unit 530, and a bias estimation unit 550. The shift registers 520 and 540 and the peak searching unit 530 all use the preamble pattern storing signal Pmatch_EN mentioned above as their enable signals, and the bias estimation unit 550 uses the matching signal Preamble_EN as its enabling signal.

Similarly, when the preamble pattern storing signal Pmatch_EN is able to enable the shift register 520, the shift register 520 starts to store and output the received signals rxi mentioned above record by record. The peak searching unit 530 electrically couples to the output of the shift register 520, so as to search and obtain a peak of the data received by the shift register 520 according to the preamble pattern storing signal Pmatch_EN during a period from the previous time of the preamble pattern storing signal Pmatch_EN enabling the shift register to the current time of the preamble pattern storing signal Pmatch_EN enabling the shift register, and to output the peak. When the shift register 540 is enabled by the preamble pattern storing signal Pmatch_EN, the peak is obtained from the output of the peak searching unit 530 and stored in a manner of shifted register. Finally, the bias estimation unit 550 obtains the peak data stored by the shift register 540 according to the potential of the matching signal Preamble_EN, and outputs an average value as the estimated DC bias Pdc after calculating the potential average value of the peak data.

In the present embodiment, even each bit period of the received signal in the preamble bit pattern only provides a peak to reduce the amount of the calculation in the bias estimation unit 550, those who are skilled in the related art can adjust the amount of data provided to the bias estimation unit or modify the condition used for data sampling based on the physical condition.

According to the circuit configuration mentioned above, the present invention can easily determine whether the received signals are the preamble bits or not according to the curve obtained by differentiating the received signal. Since the zero crossing impact due to the DC bias is totally eliminated after it is differentiated, the potential variance of each received bit is much easier to be acknowledged. Therefore, it is much faster to know the coming of the preamble bit, and much faster to obtain the estimated DC bias via the preamble bits.

Besides this, if the received signal is a trailer filed signal which together with barker code bits right before the trailer bits has the high auto-correlation characteristic, such as the bluetooth signal, this partial signal having the high auto-correlation can be further used to obtain a more accurate DC bias.

In order to achieve the object mentioned above, the present invention further provides an extra circuit configuration. FIG. 6 schematically shows a circuit block diagram for estimating which part of the signals have high correlation of a preferred embodiment according to the present invention. The present embodiment comprises a correlation unit 60 and a trailer bias estimation unit 62. The correlation unit 60 subtracts the estimated DC bias Pdc previously obtained by estimating the preamble bit filed, from the received signal rxi, so as to obtain a set of bias-reduced received signals rxi_Pdc. The set of bias-reduced received signals rxi_Pdc is then correlatively operated with a set of predefined correlation signals after it is sliced by the slicer to form a binary signal, and outputs a trailer bit enabling signal Trailer_EN or adjusts the potential of the trailer bit enabling signal Trailer_EN when the value obtained from the correlation operation is beyond a certain trailer setting threshold range. The trailer bias estimation unit 62 calculates an average value of the received signal rxi on the sampling point corresponding to the trailer bit according to the trailer bit enabling signal Trailer_EN, and outputs the calculation result as a trailer DC bias Tdc.

FIG. 6 further shows a preferred embodiment of a circuit block for implementing the circuit function mentioned above. The correlation unit 60 comprises a subtractor 602, a slicer 604, a correlation calculating element 606, an absolute value converter 608, and a comparator 610. In the present embodiment, after the received signal rxi and the estimated DC bias Pdc previously estimated from the preamble bit field are input into the subtractor 602, a corresponding bias-reduced received signal rxi_Pdc is obtained from the subtraction operation of the subtractor 602. After being sliced and forming a square wave by the slicer 604, the bias-reduced received signal rxi_Pdc is input into the correlation calculating element 606, and a correlation operation is performed on it accompanying with the barker code field together with the trailer field expected to be received (i.e. the predefined correlation signal mentioned above).

It will be apparent to one of ordinary skill in the art that when performing the correlation operation on two signals having a correlation characteristic, and these two signals are very close, the value obtained from the correlation operation increases quickly. Contrarily, if these two signals are not close enough, the value obtained from the correlation operation is relatively small. Therefore, the result obtained from the calculation of the correlation calculating element 606 is first converted into a positive value by the absolute value converter 608, and it is then compared with the trailer setting threshold value th setup in advance via the comparator 610. When the input positive value is greater than or equal to the trailer setting threshold value th, the trailer bit enable signal Trailer_EN is output or the potential of the trailer bit enabling signal Trailer_EN is adjusted. Therefore, as long as the value obtained from the calculation of the correlation calculating element 606 is beyond the trailer setting threshold range contained in the positive, negative trailer setting threshold value th, the trailer bit enabling signal Trailer_EN is used to enable the trailer bias estimation unit 62. Contrarily, if the value obtained from the calculation of the correlation calculating element 606 is within the trailer setting threshold range contained in the positive, negative trailer setting threshold value th, the trailer bit enable signal Trailer_EN cannot enable the trailer bias estimation unit 62.

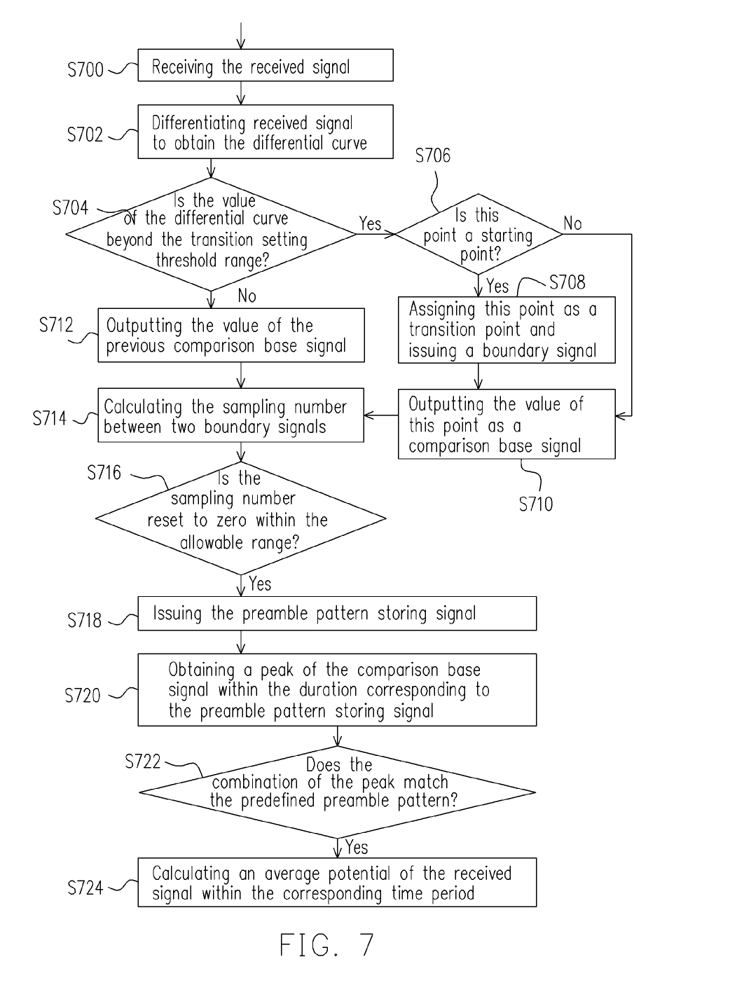

FIG. 7 schematically shows a flow chart of a preferred embodiment according to the present invention for estimating a DC bias of the received signal obtained from sampling the received packet. The method comprises steps of follows. At first, in step S700, the present embodiment receives a received signal from outside after it is sampled. Then in step S720, a differential operation is performed on the received signal, so as to obtain a corresponding differential curve. After the value of the differential curve is obtained by the differentiation and the noise elimination operation is completed, whether the value of the differential curve is beyond the predefined transition setting range or not is determined in step S704. If the value of the differential curve is beyond the transition setting range, step S706 is performed, otherwise, step S712 is performed.

In step S706, it is determined first that whether the curve value before this point is within the transition setting range or not, i.e. determining whether this point is a starting point of the differential curve beyond the transition setting range or not. If the determining result in step S706 indicates it is, step S708 is performed to assign this point as a transition point and a boundary signal is issued. Then step S710 is further performed, so as to output the curve value of this point, such that it can become part of the base signal. Contrarily, if the determining result in step S706 indicates it is not, step S710 is directly performed. When the determining result in step S704 indicates that the value of the differential curve is within the transition setting range, step S712 is performed, so as to output the value, which is the previous comparison base signal.

Then, regardless whether step S710 or S712 is performed or not, the flow enters into step S714 to calculate a sampling number between two boundary signals. The counted sampling number is reset to zero each time the boundary signal occurs. Then in step S716, it is determined whether the counted sampling number is within an allowable range or not before it is reset to zero. In other words, it is to determine whether the sampling number between two boundary signals matches a predetermined range or not, or to determine whether the time difference between two boundary signals matches the time difference required for the predefined data bit period or not. If it is determined in step S716 that the counted sampling number is beyond or below an allowable range before it is reset to zero, the operation is not performed. Otherwise, if it is determined in step S716 that the counted sampling number is within an allowable range before it is reset to zero, step S718 is performed to search and obtain a peak of the comparison base signal at a corresponding timing. Then in step S722, the pattern of the continuously obtained sliced binary comparison base signals is compared with the predefined preamble pattern, so as to determine whether the pattern of the continuously obtained sliced binary comparison base signals matches the predefined preamble pattern or not. If it is determined in step S722 that they are not matched, the operation is not performed. Otherwise, if it is determined in step S722 that they are matched, step S724 is performed on the received signal corresponding to the comparison base signal that matches the predefined preamble pattern, and calculates an average potential of the peak for each bit period of the received signal, and finally outputs it as the estimated DC bias.

Besides this, in order to handle the estimated DC bias more accurately, for the trailer field signal having high correlation subsequent to the preamble pattern and the access code field such as the bluetooth signal, the present invention subtracts the estimated DC bias obtained in step S724 from the received signal, so as to obtain the corresponding bias-reduced received signal. Then, the bias-reduced received signal is performed a correlation operation accompanying with the predefined correlation signal after it is sliced by the slicer, and outputs a trailer bit enabling signal when the value obtained from the correlation operation is beyond the trailer setting threshold range. Finally, an average value of the received signal is calculated according to the trailer bit enabling signal, and the calculation result is output as a trailer DC bias.

The present invention uses the result obtained from the auto-correlation operation of the received signal, whose DC bias has been reduced, and the predefined correlation signal, to obtain the subsequent trailer field as soon as it can. Then, the trailer filed is used to obtain a more accurate DC bias estimation.

Although the invention has been described with reference to a particular embodiment thereof, it will be apparent to one of ordinary skill in the art that modifications to the described embodiment may be made without departing from the spirit of the invention. Accordingly, the scope of the invention will be defined by the attached claims and not by the above detailed description.

1. A digital DC bias estimation apparatus for estimating a DC bias of a received signal obtained from sampling a received packet, wherein the digital DC bias estimation apparatus comprises:
a symbol boundary detection unit for differentiating the received signal to obtain a differential curve, slicing the differential curve into a sliced binary comparison base signal by assigning a starting point on a region beyond a transition setting threshold range in the differential curve as a transition point, and issuing a boundary signal when the transition is occurred;
a preamble pattern identification enabling unit for counting a sampling number between the contiguous boundary signals wherein the counted sampling number is reset to zero each time when the boundary signal is occurred, and issuing a preamble pattern storing signal before the counted sampling number reset to zero is within an allowable range;
a preamble pattern identification unit for obtaining the sliced binary comparison base signal according to the preamble pattern storing signal, comparing the continuously obtained sliced binary comparison base signals with a predefined preamble pattern, and issuing a matching signal when the pattern of the sliced binary comparison base signals matches the predefined preamble pattern; and
a bias calculation unit electrically coupled to the preamble pattern identification unit for outputting an average potential of peaks of each bit of the received signal, which is corresponded to the sliced binary comparison base signal that matches the predefined preamble pattern before the matching signal appears, as an estimated DC bias.

2. The digital DC bias estimation apparatus of claim 1 wherein the symbol boundary detection unit further comprises:
a noise eliminator for differentiating the received signal to obtain the corresponding differential curve, and moving averaging a plurality of curve values that are contiguous in the differential curve, so as to output an averaged differential curve;
a distortion alleviator for outputting an original value of the averaged differential curve when the averaged differential curve is beyond the transition setting threshold range, and outputting a previously output value when the averaged differential curve is within the transition setting threshold range, so as to form a distortion alleviated signal;
a slicer for slicing the distortion alleviated signal and generating the sliced binary comparison base signal; and
a transition detection unit for outputting the boundary signal when the transition of the sliced binary comparison base signal is occurred.

3. The digital DC bias estimation apparatus of claim 1 wherein the preamble pattern identification enabling unit further comprises:
a first counter for counting the sampling number between the contiguous boundary signals, resetting the sampling number to zero and outputting a counting zero signal each time when the boundary signal is occurred, and outputting a bit enabling signal when the counted sampling number is within an allowable range before it is reset to zero; and
an AND gate in which the counting zero signal, the bit enabling signal, and the boundary signal are input for operating the input signals and outputs the preamble pattern storing signal.

4. The digital DC bias estimation apparatus of claim 3 wherein the preamble pattern identification enabling unit further comprises:
a second counter for counting the number of the boundary signals, and enabling the AND gate when the number of the boundary signals reaches a predetermined number.

5. The digital DC bias estimation apparatus of claim 1 wherein the preamble pattern identification unit further comprises:
a shift register for storing the sliced binary comparison base signal record by record according to the preamble pattern storing signal; and
a pattern matching unit electrically coupled to the shift register for comparing the predefined preamble pattern with the data stored in the shift register.

6. The digital DC bias estimation apparatus of claim 1 wherein the bias calculation unit further comprises:
a first shift register for storing and outputting the received signal record by record according to the preamble pattern storing signal; and
a bias estimation unit electrically coupled to the first shift register for obtaining and calculating an average value of the peaks of the received signals output from the first shift register according to the matching signal, so as to obtain the estimated DC bias.

7. The digital DC bias estimation apparatus of claim 6 wherein the bias calculation unit further comprises:
a peak searching unit electrically coupled to the first shift register for obtaining a peak of the received signal stored in the first shift register during a period from the previous time of the preamble pattern storing signal enabling the shift register to the current time of the preamble pattern storing signal enabling the shift register according to the preamble pattern storing signal, and outputting the peak;
wherein, the bias estimation unit calculates an average value of the peaks in the received signal corresponded to the sliced binary comparison base signal that matches the predefined preamble pattern, so as to obtain the estimated DC bias.

8. The digital DC bias estimation apparatus of claim 7 wherein the bias calculation unit further comprises:
a second shift register electrically coupled to the peak searching unit for storing the peak output from the peak searching unit record by record according to the preamble pattern storing signal, and for outputting the stored peaks record by record in an appropriate timing.

9. The digital DC bias estimation apparatus of claim 1, further comprising:
a correlation unit for subtracting the estimated DC bias from the received signal to obtain an bias-reduced received signal, performing a correlation operation on the bias-reduced received signal and a predefined correlation signal, and outputting a trailer bit enable signal when the value obtained from the correlation operation is beyond a trailer setting threshold range; and
a trailer bias estimation unit for calculating an average value of the samples of the received signal corresponding to the trailer bit, and outputting the calculation result as a trailer DC bias.

10. A digital DC bias estimation method for estimating a DC bias of a received signal obtained from sampling a received packet wherein the digital DC bias estimation method comprises:
differentiating the received signal to obtain a differential curve;
slicing the differential curve into a sliced binary comparison base signal by assigning a starting point on a region beyond a transition setting threshold range in the differential curve as a transition point, and issuing a boundary signal when the transition is occurred;
counting a sampling number between the contiguous boundary signals wherein the counted sampling number is reset to zero each time when the boundary signal is occurred;
obtaining the sliced binary comparison base signal in the comparison base signal during a corresponding period when the counted sampling number is reset to zero within an allowable range;
comparing the continuously obtained sliced binary comparison base signals with a predefined preamble pattern, and obtaining an average value of the peaks in each bit period of the received signal corresponded to the comparison base signal that matches the predefined preamble pattern before the matching signal appears, and outputting the average potential as an estimated DC bias.

11. The digital DC bias estimation method of claim 10, further comprising:
subtracting the estimated DC bias from the received signal to obtain an bias-reduced received signal;
performing a correlation operation on the bias-reduced received signal and a predefined correlation signal, and outputting a trailer bit enable signal when the value obtained from the correlation operation is beyond a trailer setting threshold range; and
calculating an average value of the received signal at a synchronization sampling point according to the trailer bit enable signal, and outputting the calculation result as a trailer DC bias.
